(19) United States
(12) Patent Application Publication
(10) Pub. No.: US 2006/0242389 A1
(43) Pub. Date: Oct. 26, 2006

(54) Job level control of simultaneous multi-threading functionality in a processor

(75) Inventors: Luke Matthew Browning, Austin, TX (US); Thomas Stanley Mathews, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/111,556

(22) Filed: Apr. 21, 2005

(51) Int. Cl. G06F 9/00

(52) U.S. Cl. 712/229

(57) ABSTRACT

Using resource sets for job-level control of the simultaneous multi-threading capability (SMT) of a processor in a data processing system. A resource set defined with respect to the processor is adapted to control whether the simultaneous multi-threading capability is enabled.

### BACKGROUND OF THE INVENTION

1. Technical Field

The present invention relates generally to an improved data processing system and in particular to a method and apparatus for processing data. Still more particularly, the invention relates to job level control of a simultaneous multi-threading in a data processing system.

2. Description of Related Art:

Simultaneous multi-threading (SMT) is a feature of the POWER5 processor provided by International Business Machines Corporation. SMT takes advantage of the superscalar nature of modern, wide-issue processors to achieve a greater ability to execute instructions in parallel using multiple hardware threads. Thus, SMT gives the processor core the capability of executing instructions from two or more threads simultaneously, under certain conditions. SMT is expected to increase the ability of modern processors to process a job 35% to 40% faster than processors that do not have SMT capability.

On the POWER5 processor, two hardware threads are present per physical processor. Each hardware thread is configured by the operating system as a separate logical processor, so a four-way processor is seen as a logical eight-way processor.

However, the increase in performance comes at a cost. When SMT is enabled, it increases variability in execution time because a greater degree of processor and cache resource sharing occurs. For some kinds of jobs, such as for high performance customers, the greater variability in execution time is undesirable. For other jobs, the greater variability in execution time is irrelevant. Thus, the ability to disable SMT quickly is a desirable feature in a processor that has SMT capability.

Currently, in some data processing systems, SMT can be turned on or off in the hardware. However, AIX (a form of the UNIX operating system known as an advanced interactive executive operating system provided by International Business Machines Corporation) does not provide this capability. AIX implements SMT at the level of the operating system image and not at the level of the physical processor. Furthermore, it is desirable to have the capability of disabling and enabling SMT at the physical processor level and not necessarily just at the operating system image level. Thus, it would be desirable to have a method, process, and data processing system for disabling and enabling SMT at the job level in a data processing environment.

### SUMMARY OF THE INVENTION

The present invention provides for job-level control of the simultaneous multi-threading capability (SMT) of a processor in a data processing system. A resource set defined with respect to the processor is adapted to control whether the simultaneous multi-threading capability is enabled.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented.

FIG. 2 is a block diagram of a data processing system in which the present invention may be implemented.

FIG. 3 is a block diagram of a processor system for processing information.

FIG. 4 is a block diagram of resource sets in a data processing environment, in accordance with a preferred embodiment of the present invention.

FIG. 5 is a block diagram illustrating a single-thread processor operation, in accordance with a preferred embodiment of the present invention.

FIG. 6 is a block diagram illustrating a multi-thread processor operation, in accordance with a preferred embodiment of the present invention.

FIG. 7 is a flowchart illustrating a method of using a resource set to establish a single thread mode in processor capable of a simultaneous multi-thread mode, in accordance with a preferred embodiment of the present invention.

FIG. 8 is a flowchart illustrating a method of removing a resource set in order to re-establish a simultaneous multi-thread mode in a processor, in accordance with a preferred embodiment of the present invention.

### DETAILED DESCRIPTION OF THE PREFERRED EMBODIMENT

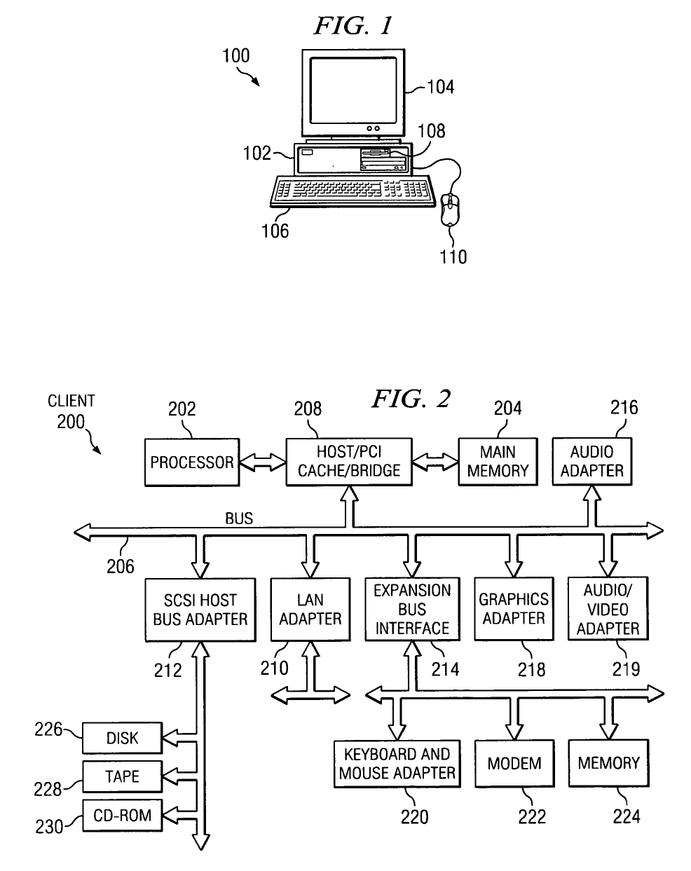

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, New York. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

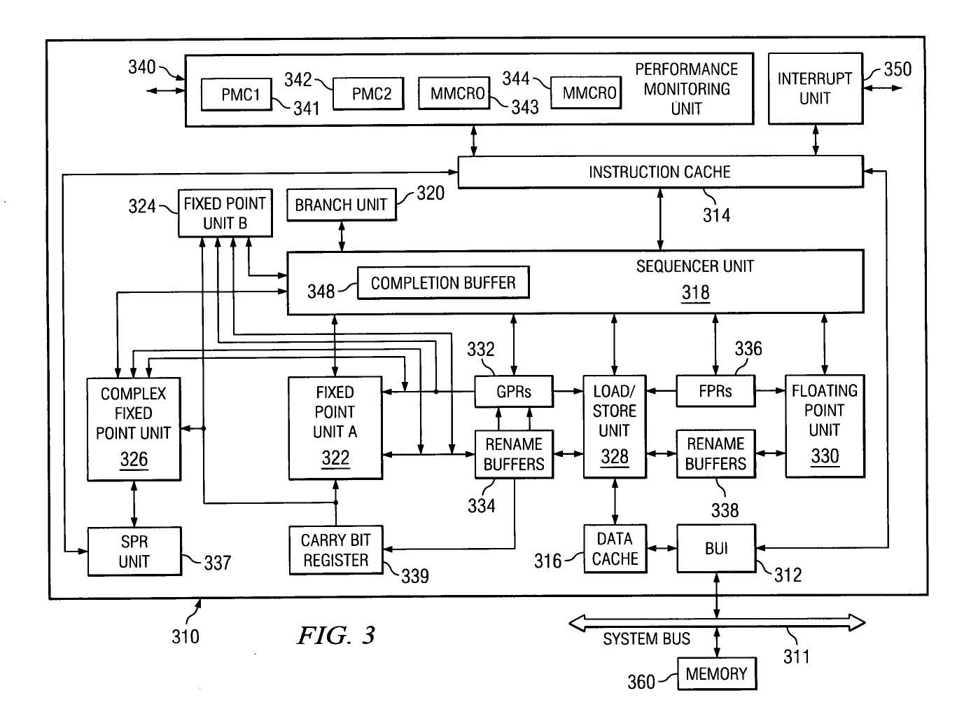

Turning next to FIG. 3, a block diagram of a processor system for processing information is depicted. Processor 310 may be implemented as processor 202 in FIG. 2. The processor shown in FIG. 3 is not capable of simultaneous multi-thread processing, though the processor shown in FIG. 3 does provide information relevant to understanding processors in general.

In a preferred embodiment, processor 310 is a single integrated circuit superscalar microprocessor. Accordingly, as discussed further herein below, processor 310 includes various units, registers, buffers, memories, and other sections, all of which are formed by integrated circuitry. Also, in the preferred embodiment, processor 310 operates according to reduced instruction set computer (“RISC”) techniques. As shown in FIG. 3, system bus 311 is connected to a bus interface unit (“BIU”) 312 of processor 310. BIU 312 controls the transfer of information between processor 310 and system bus 311.

BIU 312 is connected to an instruction cache 314 and to data cache 316 of processor 310. Instruction cache 314 outputs instructions to sequencer unit 318. In response to such instructions from instruction cache 314, sequencer unit 318 selectively outputs instructions to other execution circuitry of processor 310.

In addition to sequencer unit 318, in the preferred embodiment, the execution circuitry of processor 310 includes multiple execution units, namely a branch unit 320, a fixed-point unit A (“FXUA”) 322, a fixed-point unit B (“FXUB”) 324, a complex fixed-point unit (“CFXU”) 326, a load/store unit (“LSU”) 328, and a floating-point unit (“FPU”) 330. FXUA 322, FXUB 324, CFXU 326, and LSU 328 input their source operand information from general-purpose architectural registers (“GPRs”) 332 and fixed-point rename buffers 334. Moreover, FXUA 322 and FXUB 324 input a “carry bit” from a carry bit (“CA”) register 339. FXUA 322, FXUB 324, CFXU 326, and LSU 328 output results (destination operand information) of their operations for storage at selected entries in fixed-point rename buffers 334. Also, CFXU 326 inputs and outputs source operand information and destination operand information to and from special-purpose register processing unit (“SPR unit”) 337.

FPU 330 inputs its source operand information from floating-point architectural registers (“FPRs”) 336 and floating-point rename buffers 338. FPU 330 outputs results (destination operand information) of its operation for storage at selected entries in floating-point rename buffers 338.

In response to a Load instruction, LSU 328 inputs information from data cache 316 and copies such information to selected ones of rename buffers 334 and 338. If such information is not stored in data cache 316, then data cache 316 inputs (through BIU 312 and system bus 311) such information from a system memory 360 connected to system bus 311. Moreover, data cache 316 is able to output (through BIU 312 and system bus 311) information from data cache 316 to system memory 360 connected to system bus 311. In response to a Store instruction, LSU 328 inputs information from a selected one of GPRs 332 and FPRs 336 and copies such information to data cache 316.

Sequencer unit 318 inputs and outputs information to and from GPRs 332 and FPRs 336. From sequencer unit 318, branch unit 320 inputs instructions and signals indicating a present state of processor 310. In response to such instructions and signals, branch unit 320 outputs (to sequencer unit 318) signals indicating suitable memory addresses storing a sequence of instructions for execution by processor 310. In response to such signals from branch unit 320, sequencer unit 318 inputs the indicated sequence of instructions from instruction cache 314. If one or more of the sequence of instructions is not stored in instruction cache 314, then instruction cache 314 inputs (through BIU 312 and system bus 311) such instructions from system memory 360 connected to system bus 311.

In response to the instructions input from instruction cache 314, sequencer unit 318 selectively dispatches the instructions to selected ones of execution units 320, 322, 324, 326, 328, and 330. Each execution unit executes one or more instructions of a particular class of instructions. For example, FXUA 322 and FXUB 324 execute a first class of fixed-point mathematical operations on source operands, such as addition, subtraction, ANDing, ORing and XORing. CFXU 326 executes a second class of fixed-point operations on source operands, such as fixed-point multiplication and division. FPU 330 executes floating-point operations on source operands, such as floating-point multiplication and division.

As information is stored at a selected one of rename buffers 334, such information is associated with a storage location (e.g. one of GPRs 332 or carry bit (CA) register 342) as specified by the instruction for which the selected rename buffer is allocated. Information stored at a selected one of rename buffers 334 is copied to its associated one of GPRs 332 (or CA register 342) in response to signals from sequencer unit 318. Sequencer unit 318 directs such copying of information stored at a selected one of rename buffers 334 in response to “completing” the instruction that generated the information. Such copying is called “writeback.” As information is stored at a selected one of rename buffers 338, such information is associated with one of FPRs 336. Information stored at a selected one of rename buffers 338 is copied to its associated one of FPRs 336 in response to signals from sequencer unit 318. Sequencer unit 318 directs such copying of information stored at a selected one of rename buffers 338 in response to “completing” the instruction that generated the information.

Processor 310 achieves high performance by processing multiple instructions simultaneously at various ones of execution units 320, 322, 324, 326, 328, and 330. Accordingly, each instruction is processed as a sequence of stages, each being executable in parallel with stages of other instructions. Such a technique is called “pipelining.” In a significant aspect of the illustrative embodiment, an instruction is normally processed as six stages, namely fetch, decode, dispatch, execute, completion, and writeback.

In the fetch stage, sequencer unit 318 selectively inputs (from instruction cache 314) one or more instructions from one or more memory addresses storing the sequence of instructions discussed further hereinabove in connection with branch unit 320, and sequencer unit 318.

In the decode stage, sequencer unit 318 decodes up to four fetched instructions.

In the dispatch stage, sequencer unit 318 selectively dispatches up to four decoded instructions to selected (in response to the decoding in the decode stage) ones of execution units 320, 322, 324, 326, 328, and 330 after reserving rename buffer entries for the dispatched instructions' results (destination operand information). In the dispatch stage, operand information is supplied to the selected execution units for dispatched instructions. Processor 310 dispatches instructions in order of their programmed sequence.

In the execute stage, execution units execute their dispatched instructions and output results (destination operand information) of their operations for storage at selected entries in rename buffers 334 and rename buffers 338 as discussed further hereinabove. In this manner, processor 310 is able to execute instructions out-of-order relative to their programmed sequence.

In the completion stage, sequencer unit 318 indicates an instruction is “complete.” Processor 310 “completes” instructions in order of their programmed sequence.

In the writeback stage, sequencer 318 directs the copying of information from rename buffers 334 and 338 to GPRs 332 and FPRs 336, respectively. Sequencer unit 318 directs such copying of information stored at a selected rename buffer. Likewise, in the writeback stage of a particular instruction, processor 310 updates its architectural states in response to the particular instruction. Processor 310 processes the respective “writeback” stages of instructions in order of their programmed sequence. Processor 310 advantageously merges an instruction's completion stage and writeback stage in specified situations.

In the illustrative embodiment, each instruction requires one machine cycle to complete each of the stages of instruction processing. Nevertheless, some instructions (e.g., complex fixed-point instructions executed by CFXU 326) may require more than one cycle. Accordingly, a variable delay may occur between a particular instruction's execution and completion stages in response to the variation in time required for completion of preceding instructions.

Completion buffer 348 is provided within sequencer 318 to track the completion of the multiple instructions which are being executed within the execution units. Upon an indication that an instruction or a group of instructions have been completed successfully, in an application specified sequential order, completion buffer 348 may be utilized to initiate the transfer of the results of those completed instructions to the associated general-purpose registers.

In addition, processor 310 also includes performance monitor unit 340, which is connected to instruction cache 314 as well as other units in processor 310. Operation of processor 310 can be monitored utilizing performance monitor unit 340, which in this illustrative embodiment is a software-accessible mechanism capable of providing detailed information descriptive of the utilization of instruction execution resources and storage control. Although not illustrated in FIG. 3, performance monitor unit 340 is coupled to each functional unit of processor 310 to permit the monitoring of all aspects of the operation of processor 310, including, for example, reconstructing the relationship between events, identifying false triggering, identifying performance bottlenecks, monitoring pipeline stalls, monitoring idle processor cycles, determining dispatch efficiency, determining branch efficiency, determining the performance penalty of misaligned data accesses, identifying the frequency of execution of serialization instructions, identifying inhibited interrupts, and determining performance efficiency. The events of interest also may include, for example, time for instruction decode, execution of instructions, branch events, cache misses, and cache hits.

Performance monitor unit 340 includes an implementation-dependent number (e.g., 2-8) of counters 341-342, labeled PMC1 and PMC2, which are utilized to count occurrences of selected events. Performance monitor unit 340 further includes at least one monitor mode control register (MMCR). In this example, two control registers, MMCRs 343 and 344 are present that specify the function of counters 341-342. Counters 341-342 and MMCRs 343-344 are preferably implemented as SPRs that are accessible for read or write via MFSPR (move from SPR) and MTSPR (move to SPR) instructions executable by CFXU 326. However, in one alternative embodiment, counters 341-342 and MMCRs 343-344 may be implemented simply as addresses in I/O space. In another alternative embodiment, the control registers and counters may be accessed indirectly via an index register. This embodiment is implemented in the IA-64 architecture in processors from Intel Corporation.

The various components within performance monitoring unit 340 may be used to generate data for performance analysis. Depending on the particular implementation, the different components may be used to generate trace data. In other illustrative embodiments, performance unit 340 may provide data for time profiling with support for dynamic address to name resolution.

Additionally, processor 310 also includes interrupt unit 350, which is connected to instruction cache 314. Additionally, although not shown in FIG. 3, interrupt unit 350 is connected to other functional units within processor 310. Interrupt unit 350 may receive signals from other functional units and initiate an action, such as starting an error handling or trap process. In these examples, interrupt unit 350 is employed to generate interrupts and exceptions that may occur during execution of a program.

The present invention provides for job-level control of the simultaneous multi-threading capability (SMT) of a processor in a data processing system. A resource set defined with respect to the processor is adapted to control whether the simultaneous multi-threading capability is enabled.

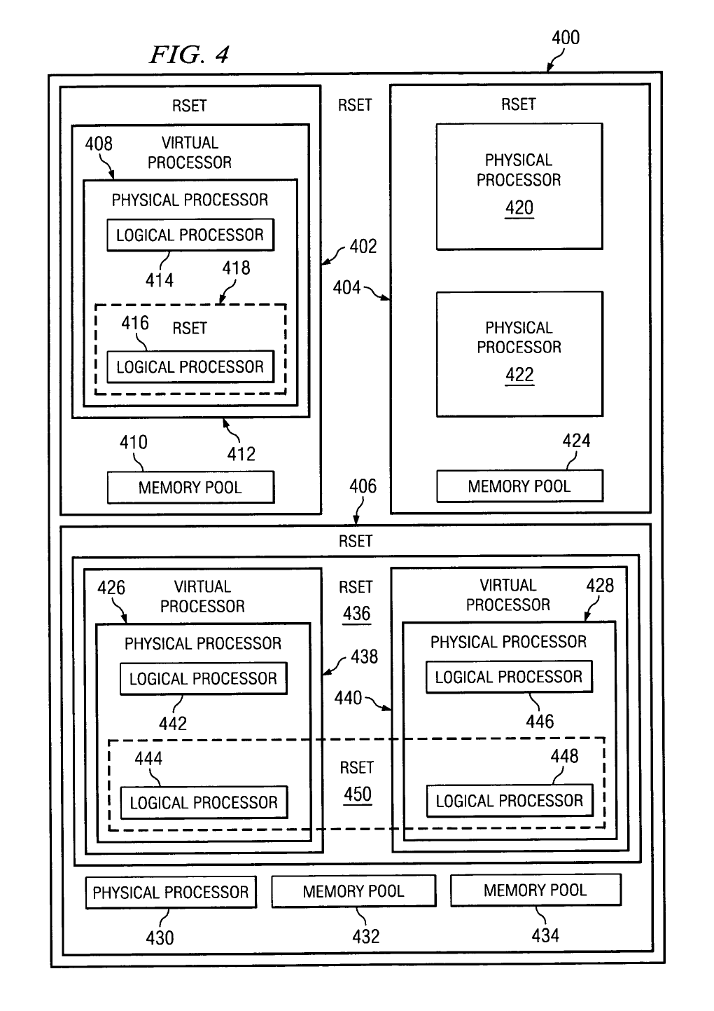

FIG. 4 is a block diagram of resource sets in a data processing environment, in accordance with a preferred embodiment of the present invention. Data processing environment 400 may be a single data processing system, such as computer 100 in FIG. 1, client 200 in FIG. 2, processor 300 in FIG. 3, a collection of processors in a single computer, or a collection of computers or processors. A data processing environment may include other data processing hardware such as routers, networks, printers, scanners, and memory pools including hard disks, RAM, ROM, tapes, and other forms of memory. A data processing environment may also include other data processing equipment.

A data processing environment 400 may contain one or more resource sets (RSET), such as resource sets 402, 404, and 406. In addition, data processing environment 400 may also be considered a resource set. In an illustrative embodiment, a resource set is a collection of processors and memory pools. Usually, resources within a resource set are perceived to be close together such that resources within a resource set respond to each other in a minimum amount of time. In other words, resources that are closer together operate in conjunction faster than similar resources that are farther apart. Each resource within a resource set may be referred to as an affinity domain and a collection of resource sets may be used to describe a hierarchical structure of affinity domains.

A resource set may be an exclusive resource set. An exclusive resource set allows only certain types of applications to be executed in the exclusive resource set. Thus, an exclusive resource set is reserved for specific tasks. For example, making a processor an exclusive resource set causes all unbound work to be shed from the processor. Only processes and threads with processor bindings and attachments may be run on a processor that has been marked as exclusive.

In the illustrative embodiment shown in FIG. 4, data processing environment 400 contains three primary resource sets (RSETs), primary resource set 402, primary resource set 404, and primary resource set 406. Primary resource set 402 contains one physical processor 408 and one memory pool 410. Primary resource set 404 contains memory pool 424 and two physical processors, physical processor 420 and physical processor 422. Primary resource set 406 contains three physical processors, processor 426, processor 428, and processor 430, and two memory pools, memory pool 432 and memory pool 434. Furthermore, in primary resource set 406, physical processors 426 and 428 are included in secondary resource set 436. Thus, FIG. 4 shows that a data processing environment may include multiple resource sets, with each resource set containing one or more processors and memory pools. FIG. 4 also shows that resources sets may be nested within each other. Nested resource sets may be displayed as a tree, with the top resource set (such as resource set 400) at the top of the tree.

As described above, resource sets describe a grouping of processor and memory resources. Resource sets are automatically produced by the operating system to describe the physical topography of the processors and memory. The operating system produces a tree of resource sets that correspond to the basic affinity domains that are evident in the hardware. The tree may be programmatically traversed to determine resources that are close to each other. Each level of the tree represents a different class of affinity domains. The top level of the tree is composed of one resource set, such as resource set 400, and is used to model all of the logical processor and memory pools in the system. As one travels down the tree, the affinity of resources within a resource set increases. Hardware threads are directly associated with logical processors, so resource sets model hardware threads and are used by the operating system to control the configuration of virtual processors and the use of hardware threads.

Physical processor 408 may be abstracted into virtual processor 412. A virtual processor is an abstraction of the resources of a physical processor. Virtual processors are defined by firmware and are controlled by firmware routines. The operating system uses these firmware routines to enable and disable hardware threads. A virtual processor is said to be in simultaneous multi-thread (SMT) mode when the appropriate firmware routines have been used to enable multiple hardware threads. A virtual processor is in single thread (ST) mode, when it is configured to use a single hardware thread.

The operating system controls whether a virtual processor is in ST or SMT mode. When enabling a hardware thread, the operating system allocates a new logical processor to accommodate the new hardware thread. In FIG. 4, the operating system has allocated logical processor 414 and logical processor 416. Each logical processor is, itself, and abstraction that represents a portion of the resources of physical processor 408.

When disabling a hardware thread, the operating system removes a logical processor. The operating system simply changes the state of the particular logical processor to offline in order to indicate that the logical processor is not available for use. Therefore, a logical processor may correspond to a physical processor or it may correspond to a hardware thread of a physical processor, depending on the configuration of the virtual processor. As described above, hardware threads are directly associated with logical processors, so resource sets model hardware threads and are used by the operating system to control the configuration of virtual processors and the use of hardware threads.

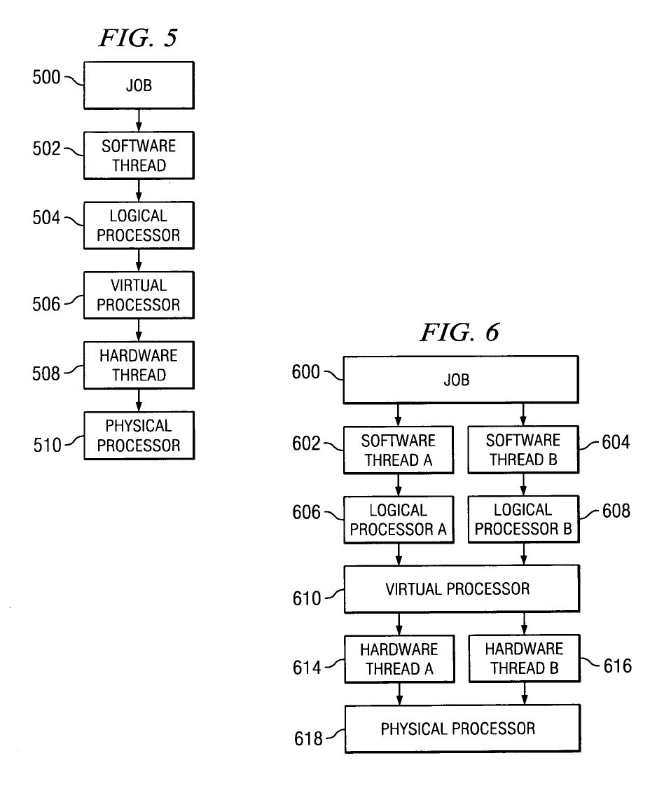

The mechanism of the present invention may be described with respect to primary resource set 402 and in particular with respect to physical processor 408. Initially, physical processor 408 operates in simultaneous multi-thread mode. However, a new resource set 418, shown in phantom, may be defined with respect to physical processor 408. New resource set 418 includes logical processor 416. The operation of new resource set 418 may be better understood after considering the operation of SMT and ST modes described in relation to FIG. 5 and FIG. 6.

FIG. 5 is a block diagram illustrating a single-thread processor operation, in accordance with a preferred embodiment of the present invention. The process shown in FIG. 5 may be implemented in a data processing environment, such as data processing environment 400 shown in FIG. 4. A job is established for execution on a processor (block 500). A job is a set of instructions, such as an application or program, that is to be executed by the processor. The job is executed in a single software thread (block 502). Thus, the job is not divided into sub-sets of instructions which are executed simultaneously.

Logical processor or processors, which are visible to the job, begin processing the job (block 504). Virtual processor or processors underlying the logical processors therefore also begin processing the job (block 506). Similarly, the physical processor or processors underlying the virtual processors and logical processors begin processing the job (block 508). Thus, a portion of the virtual processor's resources, which is a portion of the physical processor's resources, processes the job along a single thread. The operating system then uses firmware routines to enable and disable hardware threads (block 508) to process the job. In this manner, physical processor processes the job (block 510) along a single thread. Accordingly, virtual processor 506 shown in FIG. 5 is in single thread mode. The process terminates when the job is completed.

FIG. 6 is a block diagram illustrating a multi-thread processor operation, in accordance with a preferred embodiment of the present invention. The process shown in FIG. 6 may be implemented in a data processing environment, such as data processing environment 400 shown in FIG. 4. A job is established for execution on a processor (block 600). However, unlike the process shown in FIG. 5, different components of the job are processed simultaneously along at least two different software threads, such as Thread A (block 602) and Thread B (block 604). Thread A is processed on Logical Processor A (block 606) and Thread B is processed on Logical Processor B (block 608). In turn, the Virtual Processor (block 610) and the operating system establish Hardware Thread A (block 614) and Hardware Thread B (block 616), which process the job. In this way, the physical processor (block 618) processes the job along two threads simultaneously. Accordingly, the virtual processor shown in FIG. 6 is in simultaneous multi-thread mode.

Although the illustrative embodiment shows a job processed along two hardware threads, the job may be processed along any number of threads. Thus, the virtual processor shown in FIG. 6 may be referred to as a simultaneous multi-thread (SMT) processor.

Because each logical processor is a part of a virtual processor, the virtual processor is also involved in executing the threads (block 610). Similarly, because the virtual processor is involved in processing the threads, the physical processor is involved in processing the threads (block 618). Thus, a portion of the virtual processor's resources, which is a portion of the physical processor's resources, processes the job using multiple hardware threads. The process terminates when the job is completed.

Although simultaneous multi-thread processing is a powerful tool for increasing throughput on a processor, the technology has a disadvantage relative to single thread processing. Because resources on a processor or associated with a processor, such as a cache, are shared, variability in the execution time may arise. For certain tasks, it is desirable that each execution of an application take a precise amount of time so that a user knows how long a particular application will take to execute. For these tasks, single thread processing is desirable. However, for other tasks for which variability is not an issue, the same user may want to use simultaneous multi-thread processing. In addition, a single thread operation is more robust and, for the single thread, faster than a multi-thread operation. Simultaneous multi-threading has its advantages also and has been measured in some cases to increase throughput by 35% percent, however, the speed of an individual transaction may be slowed down. Thus, it would be advantageous to have a means for on-demand enabling and disabling of SMT capabilities in a processor.

Turning again to FIG. 4, FIG. 4 shows a method of establishing on-demand enabling and disabling of SMT capabilities in a processor. A new resource set (RSET) may be defined such that the resource set is adapted to control whether simultaneous multi-threading capability is enabled. In the illustrative embodiment, new resource set 418 is defined to encompass logical processor 416, corresponding virtual processor 412, and corresponding physical processor 408. In the illustrative embodiment, new resource set 418 is defined to be an exclusive resource set.

Because new resource set 418 is defined to be an exclusive resource set, logical processor 416 is likely to become idle, because only allowed processes are allowed to be executed by logical processor 416. In response, the hypervisor component of the firmware will automatically convert the virtual processor into single thread mode in dedicated partitions.

Thus, when a job is to be executed on physical processor 408 (virtual processor 412), only a single software thread will be established in logical processor 414. Logical processor 416 is not used. Thus, establishing new exclusive resource set 418 effectively converts simultaneous multi-threading processor 408 into single thread mode.

In other words, establishing new exclusive resource set 418 creates an environment in which it is much more likely that the state of logical processors 414 and 416 will change. When a logical processor is idle, the logical processor is in an exclusive state. On the other hand, when exclusive resource set 418 is not present, then both logical processors, 414 and 416 are not idle. In this case, the processors are in a non-exclusive state. When the processors are in an exclusive state, then all processors associated with physical processor 408 operate in single thread mode; otherwise, they operate in simultaneous multi-thread mode.

However, even after establishing exclusive resource set 418, logical processor 416 may still be executing a thread because a particular bound thread may still be associated with logical processor 416. In this case, virtual processor 412 is not converted into single thread mode as logical processors 414 and 416 are not idle. Nevertheless, logical processor 416 will not be used as much because it is within an exclusive resource set, thereby increasing the likelihood that it will become idle. Furthermore, the continuing processes in logical processor 416 are likely to end and, moreover, other processing functions are assigned to the other logical processors. Thus, when exclusive resource set 418 is established, logical processor 416 will eventually become idle, thereby disabling simultaneous multi-threading mode in physical processor 408.

Establishing exclusive resource set 418 may be accomplished via commands contained within a job. Similarly, a job may contain commands that remove exclusive resource set 418, thereby allowing simultaneous multi-threading process to be used. Thus, a job can control whether the job will be processed using single thread processing or simultaneous multi-thread processing. Although the instructions for establishing exclusive resource set 418 may be implemented in a job, exclusive resource set 418 may be established at any convenient time and in any convenient manner. Thus, a user may establish or remove exclusive resource set 418 on-demand and then run jobs as needed.

Although the illustrative embodiment shown in FIG. 4 shows a particular resource set configuration in data processing environment 400, resource configurations and resource sets may be defined in many different ways. For example, more or fewer resources and resource sets may be defined. In another example, resource set 418 may be a non-exclusive resource set and still cause physical processor 408 to operate in single thread mode, depending on the job and the architecture of the various physical, virtual, and logical processors.

In addition, resource sets may be established across multiple physical processors to enable or disable SMT mode in more than one physical processor. For example, in resource set 406, resource set 436 includes two physical processors, physical processor 426 and physical processor 428. Virtual processor 438 is associated with physical processor 426 and virtual processor 440 is associated with physical processor 428. Logical processors 442 and 444 are associated with physical processor 426 and logical processors 446 and 448 are associated with physical processor 428. In this illustrative embodiment, new exclusive resource set 450, shown in phantom, is established to include logical processor 444 and logical processor 448, even though these two logical processors exist within different physical processors.

When new exclusive resource set 450 is established, logical processors 444 and 448 will become idle, as described above with respect to logical processor 416 in resource set 402. Once logical processors 444 and 448 become idle, the hypervisor in each physical processor 426 and 428 will automatically cause physical processors 426 and 428 to operate in single thread mode, as described above. Thus, the mechanism of the present invention may be used to change the operating mode of multiple processors simultaneously. Accordingly, the mechanism of the present invention may be used in a vast number of configurations in a data processing environment.

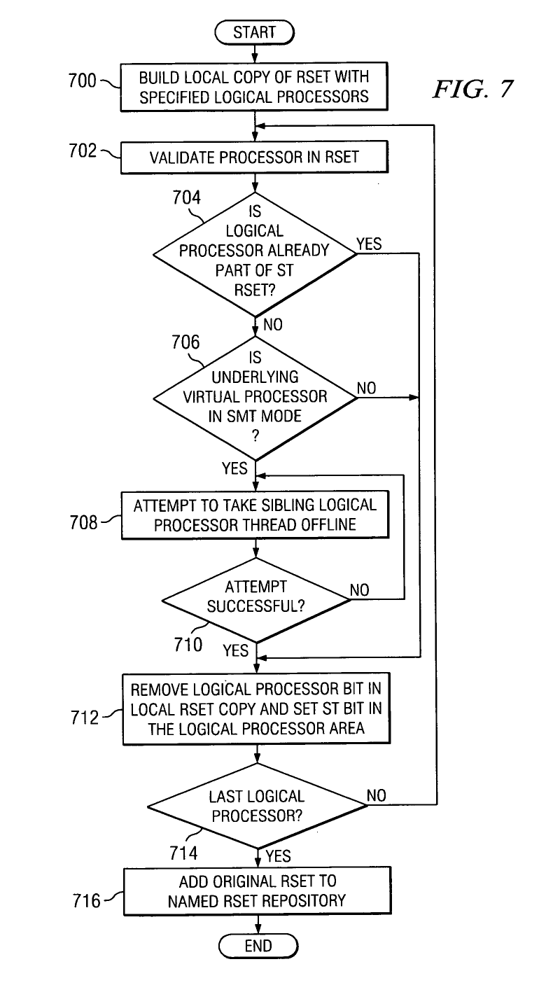

FIG. 7 is a flowchart illustrating a method of using a resource set to establish a single thread mode in processor capable of a simultaneous multi-thread mode, in accordance with a preferred embodiment of the present invention. The method shown in FIG. 7 may be implemented in the data processing environment shown in FIG. 4.

The process begins with a user or a job building a local copy of a resource set (RSET) with the specified logical processors (step 700). All sibling logical processors are specified in the resource set. Because the configuration of a processor not specified in the resource set should not be changed, the mechanism establishing the resource set validates that all affected logical processors are specified in the resource set (step 702). If the validation fails, then the process terminates.

A determination is then made whether a logical processor is offline or is already part of a resource set operating in single thread mode (ST RSET) (step 704). If the logical processor is already part of a resource set operating in single thread mode, then the logical processor bit in the local resource set copy is removed and a single thread mode bit is set in the logical processor array (step 712). The process then continues to step 714, as described below.

Returning to step 704, if the logical processor is not already part of a resource set operating in single thread mode, then a determination is made whether the underlying virtual processor is operating in simultaneous multi-thread mode (step 706). If not, then the process proceeds to step 712 as described above. If the underlying virtual processor is operating in simultaneous multi-thread mode, then a dynamic reconfiguration command or script is executed to attempt to take a sibling logical processor thread offline (step 708). A determination is then made whether the attempt is successful (step 710).

If the attempt to take the logical processor thread offline fails, then another attempt is made. Alternatively, if another attempt cannot succeed, or after a predetermined number of attempts have been made, the process may be made to terminate. However, the implementation may not fail with the assumption that an idle logical processor will convert the underlying virtual processor into single thread mode, if an exclusive resource set is being used. The request may also be treated as advisory and thus not fail. If the attempt to take the logical processor thread offline is successful, then the logical processor bit in the local resource set copy is removed and a single thread process mode flag is added to a logical processor area array (step 712).

A determination is then made whether the last logical processor has been processed for the resource set to be defined (step 714). If the last logical processor has not been processed, then the process returns to step 704 and the process is repeated until all logical processors have been processed. Once the last logical processor has been processed, the original resource set is added to the named resource set repository (step 716), with the process terminating thereafter.

After performing the method illustrated in FIG. 7, a resource set is established for one or more logical processors. In an illustrative embodiment, the resource set is an exclusive resource set. The new resource set will cause the physical processor and/or virtual processors associated with the logical processors to operate in single thread mode, as described in relation to FIG. 4.

A similar process may be invoked for establishing a resource set that will cause a processor to operate in simultaneous multi-thread process mode. Thus, if a processor otherwise capable of SMT processing is currently operating in single thread process mode, then the steps shown in FIG. 7 may be taken to establish a resource set that causes the processor to operate in SMT process mode. In this case, however, the logical processors are made on-line and the logical processor bits are added in the local resource set copy.

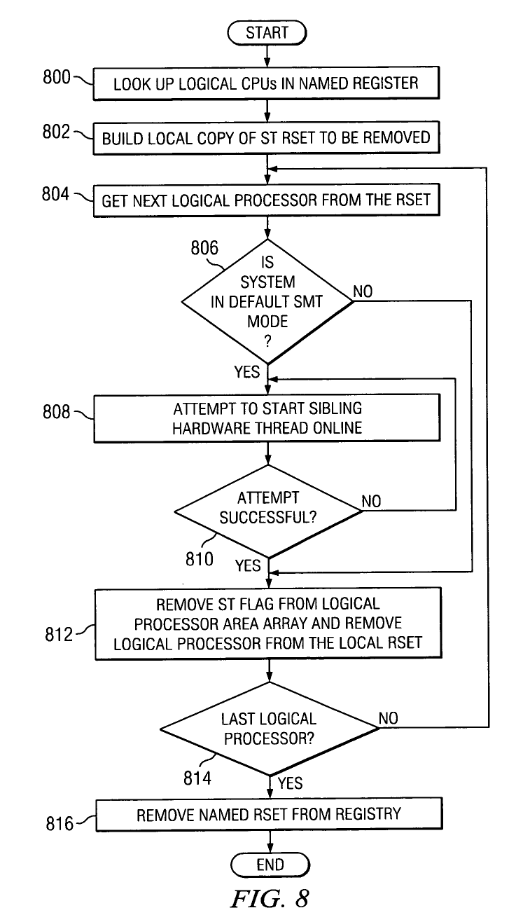

FIG. 8 is a flowchart illustrating a method of removing a resource set in order to re-establish a simultaneous multi-thread mode in a processor, in accordance with a preferred embodiment of the present invention. The method shown in FIG. 8 may be implemented in the data processing environment shown in FIG. 4. The method illustrated in FIG. 8 may be used to re-establish simultaneous multi-thread processing in a processor for which an exclusive resource set was established to force single thread processing. In other words, the method shown in FIG. 8 can undo the method shown in FIG. 7.

The process begins with looking up logical CPUs in the named register (step 800). A local copy of the single thread mode resource set to be removed is then built (step 802). Then, the program implementing the method gets the next logical processor from the resource set (step 804). A determination is then made if the system is in simultaneous multi-thread mode by default (step 806). If not, then the single thread mode flag is removed from the logical processor area array and the logical processor is removed from the local resource set(step 812). The process then continues to step 814.

Returning to step 806, if the system is in simultaneous multi-thread mode by default, then an attempt is made to start a sibling hardware thread online to start a logical processor (step 808). A determination is then made whether the attempt was successful (step 810). If the attempt was not successful, then the process returns to step 808 and another attempt is made. Multiple attempts may be made to start the hardware thread for the logical processor. Alternatively, if a predetermined number of attempts is reached or if the attempt fails for a predetermined reason, then the process may terminate.

If the attempt to start the hardware thread is successful, then the single thread mode flag is removed from the logical processor area array and the logical processor is removed from the local resource set (step 812) using a dynamic resource command, as described above. A determination is then made whether the last logical processor in the resource set has been processed (step 814). If the last logical processor has not been processed, then the process returns to step 804 and the process repeats until the last logical processor is processed. When the last logical processor is processed, then the resource set is removed from the named resource set registry (step 816). The process terminates thereafter.

The mechanism of the present invention provides several advantages over currently available methods of controlling the simultaneous multi-threading capability of a processor. For example, because the job itself is able to control SMT capability, then jobs with different requirements can be executed using SMT or ST as desired without manually adjusting the processors. For example, if one job performs better without SMT enabled and a second job performs better with SMT enabled, then the processor can execute the first job without SMT and quickly begin execution of the second job with SMT, without requiring a pause to manually issue a command to re-enable SMT. Thus, the mechanism of the present invention allows for the overall throughput of the processor to increase relative to currently available processors that control SMT only at the operating system level.

In addition, the logical processor is turned off using the mechanism of the present invention, which allows 100% of the physical processor's resources to be directed to the sibling logical processor. The exclusive resource set solution does not guarantee that the second logical processor will not be used. However, establishing an exclusive resource set makes using the logical processor less likely. Jobs with attachments can be scheduled on the idle logical processor which, in addition, may be woken to process external interrupts. An offline logical processor cannot be woken for any reason. It can only be restarted.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A data processing system comprising:
a bus;
a memory operably connected to the bus;
a processor operably connected to the bus, said processor having a simultaneous multi-threading capability; and
a resource set defined with respect to the processor, said resource set adapted to control whether the simultaneous multi-threading capability is enabled.

2. The data processing system of claim 1, wherein the resource set is an exclusive resource set.

3. The data processing system of claim 1, wherein the resource set is defined by instructions contained in a job executed on the processor.

4. The data processing system of claim 1, wherein the resource set controls whether the simultaneous multi-threading capability is enabled by controlling a state of logical processors associated with the processor.

5. The data processing system of claim 4, wherein the state is selected from the group consisting of an exclusive state and a non-exclusive state.

6. The data processing system of claim 1, wherein the processor comprises a first logical processor and a second logical processor, wherein the second logical processor is made idle using the resource set, and wherein the first logical processor and the second logical processor are associated with hardware threads on the same physical processor.

7. The data processing system of claim 6, further comprising:
a hypervisor, said hypervisor adapted to convert processors associated with the first and second logical processors into single thread operation mode.

8. A method of controlling whether a simultaneous multi-threading capability of a processor in a data processing system is enabled, said method comprising:
establishing a resource set within the data processing system;
wherein the resource set is adapted to control whether the simultaneous multi-threading capability is enabled.

9. The method of claim 8, wherein the resource set is an exclusive resource set.

10. The method of claim 8, wherein the resource set is defined by instructions contained in a job executed on the processor.

11. The method of claim 8, wherein the resource set controls whether the simultaneous multi-threading capability is enabled by controlling a state of logical processors associated with the processor.

12. The method of claim 11, wherein the state is selected from the group consisting of an exclusive state and a non-exclusive state.

13. The method of claim 8, wherein the processor comprises a first logical processor and a second logical processor, wherein the second logical processor is made idle using the resource set, and wherein the first logical processor and the second logical processor are associated with hardware threads on the same physical processor.

14. The method of claim 13, wherein in the method the data processing system further comprises a hypervisor, said hypervisor adapted to convert processors associated with the first and second logical processors into single thread operation mode.

15. A computer program product in a computer readable medium, said computer program product adapted to control whether a simultaneous multi-threading capability of a processor in a data processing system is enabled, said computer program product adapted to carry out the steps of:
establishing a resource set within the data processing system;
wherein the resource set is adapted to control whether the simultaneous multi-threading capability is enabled.

16. The computer program product of claim 15, wherein the resource set is an exclusive resource set.

17. The computer program product of claim 15, wherein the resource set is defined by instructions contained in a job executed on the processor.

18. The computer program product of claim 15, wherein the resource set controls whether the simultaneous multi-threading capability is enabled by controlling a state of logical processors associated with the processor.

19. The computer program product of claim 18, wherein the state is selected from the group consisting of an exclusive state and a non-exclusive state.

20. The computer program product of claim 15, wherein the processor comprises a first logical processor and a second logical processor, wherein the second logical processor is made idle using the resource set, and wherein the first logical processor and the second logical processor are associated with hardware threads on the same physical processor.
